(19) United States
(12) Patent Application Publication
(10) Pub. No.: US 2026/0058404 A1
(43) Pub. Date: Feb. 26, 2026

(54) COVER FOR A CONNECTOR AND CONNECTOR

(71) Applicant: TE Connectivity Solutions GmbH, Schaffhausen (CH)

(72) Inventors: Kristin Billstrand, Winston Salem, NC (US); William John Remaley, Winston Salem, NC (US); Sterling Vaden, Winston Salem, NC (US); Kimberly Ann DeBock, Winston Salem, NC (US)

(73) Assignee: TE Connectivity Solutions GmbH, Schaffhausen (CH)

(21) Appl. No.: 18/813,709

(22) Filed: Aug. 23, 2024

(51) Int. Cl. H01R 13/58

(52) U.S. Cl. CPC H01R 13/5804

(57) ABSTRACT

A cover for a connector includes a base and a support connected to the base. The base has an end wall with a cover cable passageway extending through the end wall. The support extends from the end wall around the cover cable passageway. The support has a support surface with a first end adjacent to the cover cable passageway and a second end opposite the first end. The support surface is curved between the first end and the second end to support a bending radius of a cable extending through the cover cable passageway.

### FIELD OF THE INVENTION

The present invention relates to a connector and, more particularly, to a cover for a connector.

### BACKGROUND OF THE INVENTION

Connectors often include a cable connected to a terminal within a housing. The connector has a mating end matable with a mating connector and the cable extends out of an end of the housing opposite the mating end. In certain applications, the cable extending out of the housing is bent to an orientation that is different, for example perpendicular, to the orientation of the cable within the housing. The bent portion of the cable is unsupported outside of the connector, however, which can lead to overbending, kinking, or pinching of the cable, which damages the cable and decreases the effectiveness and useful life of the cable assembly.

### SUMMARY OF THE INVENTION

A cover for a connector includes a base and a support connected to the base. The base has an end wall with a cover cable passageway extending through the end wall. The support extends from the end wall around the cover cable passageway. The support has a support surface with a first end adjacent to the cover cable passageway and a second end opposite the first end. The support surface is curved between the first end and the second end to support a bending radius of a cable extending through the cover cable passageway.

### BRIEF DESCRIPTION OF THE DRAWINGS

The invention will now be described by way of example with reference to the accompanying Figures, of which:

FIG. 1 is a perspective view of a connector according to an embodiment;

FIG. 2 is a perspective view of a cover of the connector;

FIG. 3 is a perspective view of a cover according to another embodiment;

FIG. 4 is a sectional side view of the connector of FIG. 1 with a cable;

FIG. 5 is another sectional side view of the connector with the cable; and

FIG. 6 is a sectional side view of a connector with a cable according to another embodiment including a backshell.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “longitudinal direction”, “lateral direction,” and “width direction”. These descriptors are merely for clarity of the description and for differentiation of the various directions. These directional descriptors do not imply or require any particular orientation of the disclosed elements.

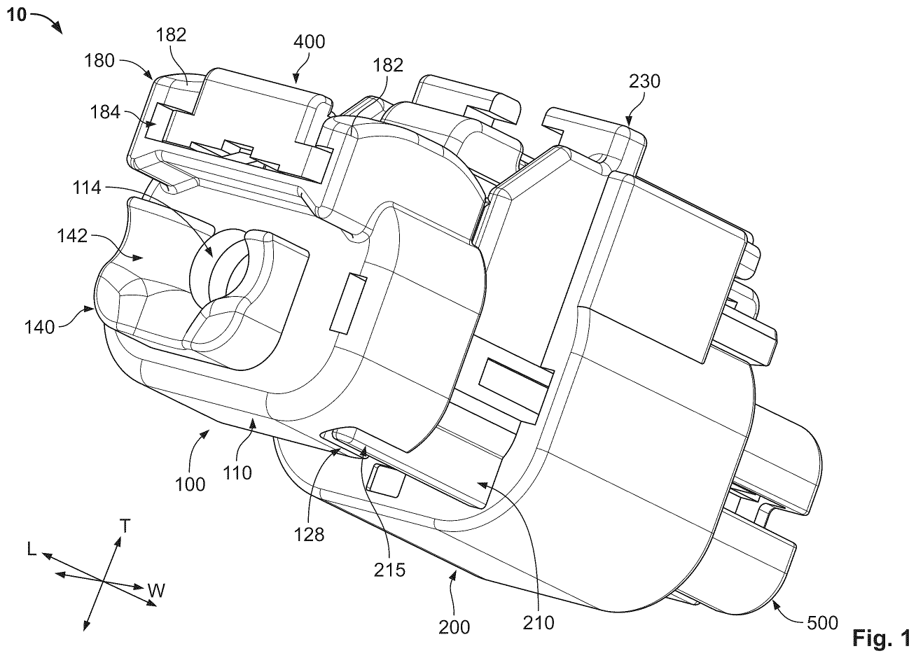

A connector 10 according to an embodiment is shown in FIG. 1. The connector 10 includes a cover 100 and a housing 200 on which the cover 100 is disposed. The cover 100 includes a base 110 and a support 140 connected to and extending from the base 110.

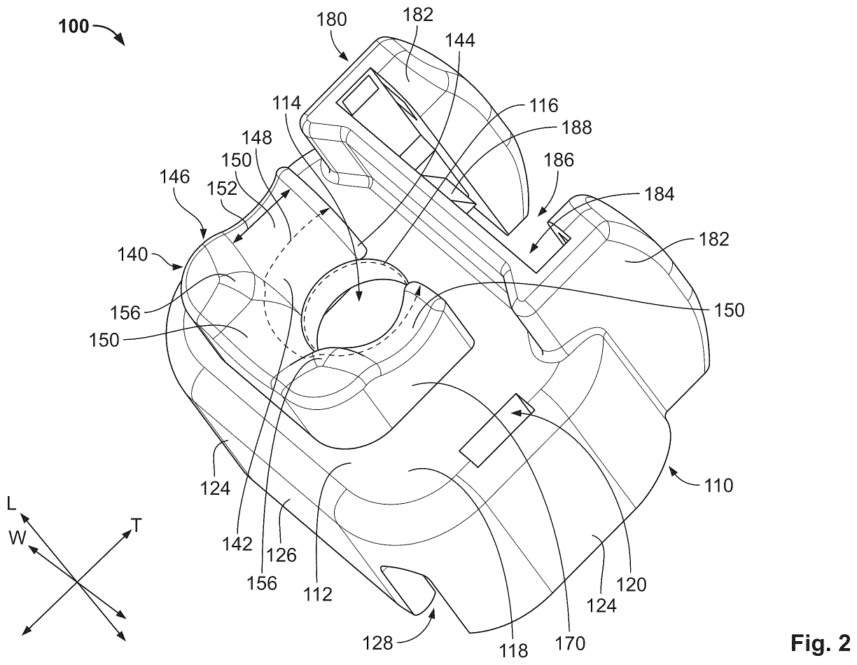

As shown in FIG. 2, the base 110 of the cover 100 has an end wall 112 and a plurality of sidewalls 124 extending from the end wall 112 in a longitudinal direction L. The end wall 112 extends in a plane defined by a width direction W perpendicular to the longitudinal direction L and a lateral direction T perpendicular to the width direction W and the longitudinal direction L. The end wall 112 has a cover cable passageway 114 extending through the end wall 112 along the longitudinal direction L. In the shown embodiment, the cover cable passageway 114 is positioned approximately centrally in the end wall 112. The cover cable passageway 114 has a circumference 116 surrounding the opening of the passageway 114 and, in the shown embodiment, is cylindrical with a circular cross-section.

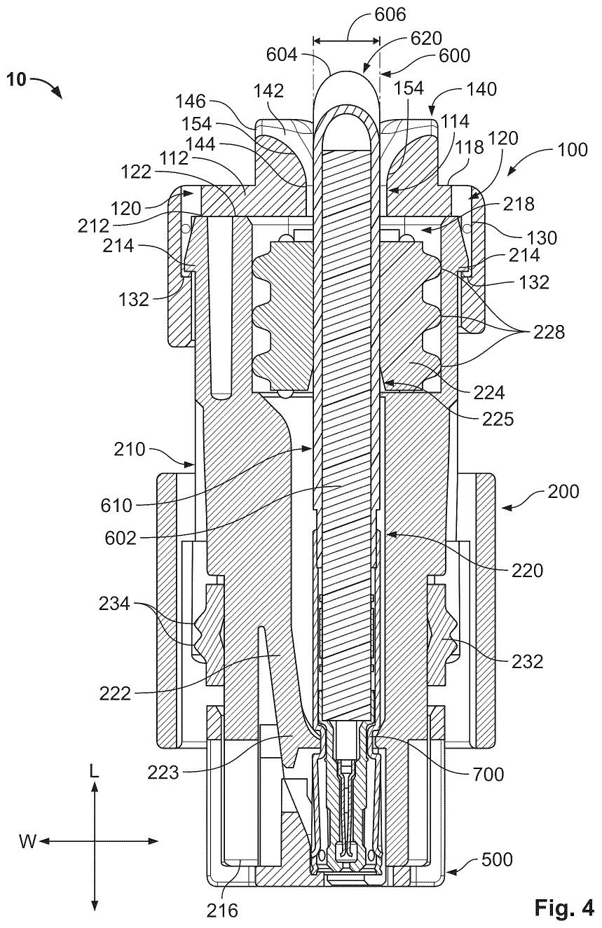

The end wall 112 of the base 110, as shown in FIGS. 2 and 4, has an outer surface 118 and, in the shown embodiment, has a plurality of access passageways 120 extending through the outer surface 118 and through the end wall 112 in the longitudinal direction L. The end wall 112, as shown in FIG. 4, has an inner surface 122 opposite the outer surface 118 in the longitudinal direction L.

The sidewalls 124 of the base 110, as shown in FIGS. 2 and 4, have an outer surface 126 and an inner surface 130 opposite the outer surface 126. The sidewalls 124 have a coding opening 128 extending into a portion of the sidewalls 124 along the longitudinal direction L, as shown in FIGS. 1 and 2. The coding opening 128, in the shown embodiment, extends from an end of the sidewalls 124 opposite the end wall 112 and is spaced apart from the end wall 112. The inner surface 130 of the sidewalls 124, as shown in FIG. 4, has a pair of cover catches 132 positioned opposite one another in the width direction W. The cover catches 132 are ledges or stops that extend in from the inner surface 130 of the sidewalls 124 in the width direction W.

The support 140, as shown in FIG. 2, is connected to and extends from the end wall 112 of the base 110 along the longitudinal direction L. The support 140 extends around the cover cable passageway 114. The support 140 has a support surface 142 with a first end 144 adjacent to the cover cable passageway 114 and a second end 146 opposite the first end 144.

As shown in FIG. 2, the support surface 142 has an inner perimeter 148 that extends around a portion of the cover cable passageway 114. In the shown embodiment, the inner perimeter 148 of the support 140 extends around more than half and less than an entirety of the circumference 116 of the cover cable passageway 114. In other embodiments, the support 140 could extend around less than half of the cover cable passageway 114 or around an entirety of the circumference 116 of the cover cable passageway 114.

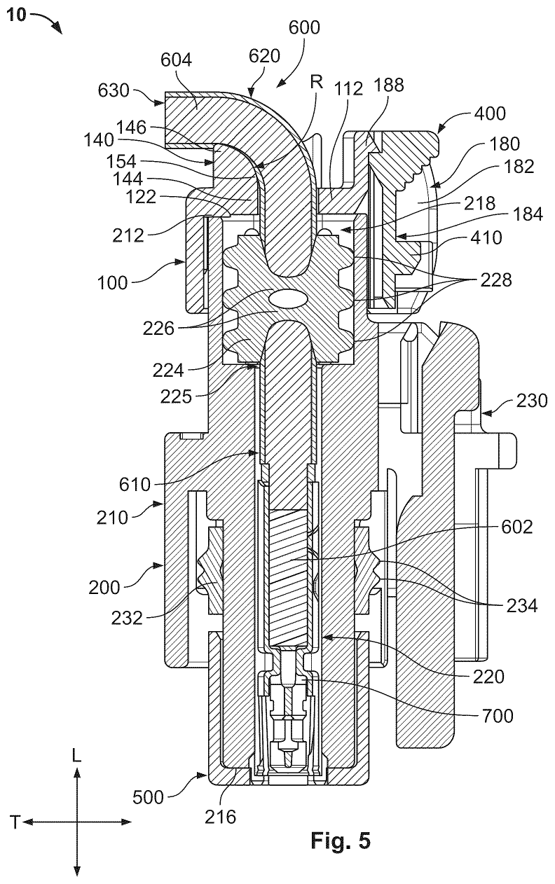

The support surface 142 is curved between the first end 144 and the second end 146, bending or arcing away from the first end 144 at the cover cable passageway 114 to the second end 146. In the embodiment shown in FIG. 2, the support surface 142 has a plurality of discrete grooves 150 separated from one another around the inner perimeter 148 of the support surface 142. Adjacent grooves 150 of the plurality of grooves 150 are separated by a ridge 156, which is a raised portion of the support surface 142. Each of the grooves 150 has a groove width 152 extending along the inner perimeter 148 and a groove curve 154, shown in FIGS. 4 and 5, extending from the first end 144 to the second end 146.

In the embodiment shown in FIG. 2, the discrete grooves 150 include three grooves 150 that are each 90° from one another around the cover cable passageway 114, with two ridges 156 separating the grooves 150. In other embodiments, the discrete grooves 150 on the support surface 142 could include two groove 150 separated by one ridge 156 or more than three grooves 150 separated by more than two ridges 156. In other embodiments, the angular spacing between the discrete grooves 150 may also be different than 90°, such as 30°, 45°, or 60°, depending on the application and the desired angular exit orientation of a cable 600, as described in greater detail below.

At a surface of the support 140 opposite the support surface 142, as shown in FIG. 2, the support 140 has an outer wall 170. In the shown embodiment, the outer wall 170 extends straight along the longitudinal direction L from the end wall 112 to the second end 146 of the support surface 142.

As shown in FIG. 2, the cover 100 has a retention section 180 extending from the sidewalls 124 of the base 110. The retention section 180 has a pair of arms 182 that are spaced apart from one another. The pair of arms 182 define a slot 184 between the arms 182 and the base 110 in the lateral direction T. The pair of arms 182 also define a retention passageway 186 between the arms 182 in the width direction W. The retention section 180 has a retention catch 188 protruding into the slot 184 in the lateral direction T.

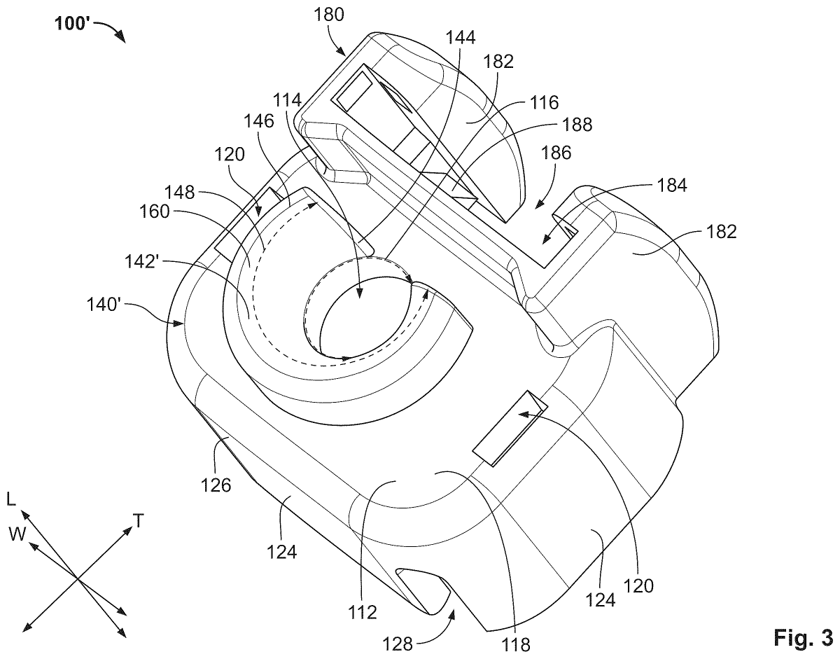

A cover 100′ according to another embodiment is shown in FIG. 3. Like references refer to like elements with respect to the embodiment shown in FIG. 2 and primarily the differences of the embodiment shown in FIG. 3 will be described herein. The cover 100′ in the embodiment of FIG. 3 has a different support 140′ and, more particularly, a different support surface 142′. As shown in FIG. 3, the support surface 142′ has a continuous curve 160 from the first end 144 to the second end 146 instead of the discrete grooves 150 and ridges 156. The continuous curve 160 is constant along the inner perimeter 148 that extends around the cover cable passageway 114.

The cover 100, 100′ according to the embodiments described above, including the base 110 and the support 140, 140′, may be formed from an insulative material, such as a plastic. In the shown embodiments, the support 140, 140′ is monolithically formed in a single piece with the base 110.

The housing 200, as shown in FIGS. 4 and 5, includes a body 210 and a connection section 230 extending from the body 210. The body 210 has a cover end 212 and a plug end 216 opposite the cover end 212 in the longitudinal direction L.

At the cover end 212, as shown in FIG. 4, the body 210 of the housing 200 has a pair of cover latches 214 that protrude outward in the width direction W and are opposite one another in the width direction W. The body 210 has a recess 218 extending into the cover end 212 along the longitudinal direction L. As shown in FIG. 1, the body 210 has a coding protrusion 215 extending outward from the body 210 in the lateral direction T.

As shown in FIGS. 4 and 5, the body 210 of the housing 200 has a housing cable passageway 220 extending through the body 210 from the cover end 212 to the plug end 216 along the longitudinal direction L. The housing cable passageway 220 communicates with the recess 218 at the cover end 212.

The housing 200, as shown in FIG. 4, has a retention arm 222 extending from the body 210 into the housing cable passageway 220. The retention arm 222 is cantilevered and extends from the body 210 to a free end 223. The retention arm 222 is resiliently deflectable with respect to the body 210 within the housing cable passageway 220.

The housing 200, including the body 210 and the connection section 230, is formed from an insulative material, such as a plastic. In the shown embodiment, the housing 200 is monolithically formed in a single piece from the insulative material.

As shown in FIGS. 4 and 5, the housing 200 has a cable seal 224 positioned within the body 210. The cable seal 224 is formed from an elastomeric material and has a seal passageway 225 extending through the cable seal 224 along the longitudinal direction L. The cable seal 224 has a plurality of inner ribs 226 extending into the seal passageway 225 and a plurality of outer ribs 228 extending outward from the cable seal 224.

As shown in FIGS. 4 and 5, a connector seal 232 is positioned around the body 210 of the housing 200 between the connection section 230 and the body 210 of the housing 200. The connector seal 232 is formed from an elastomeric material and has a plurality of outer ribs 234.

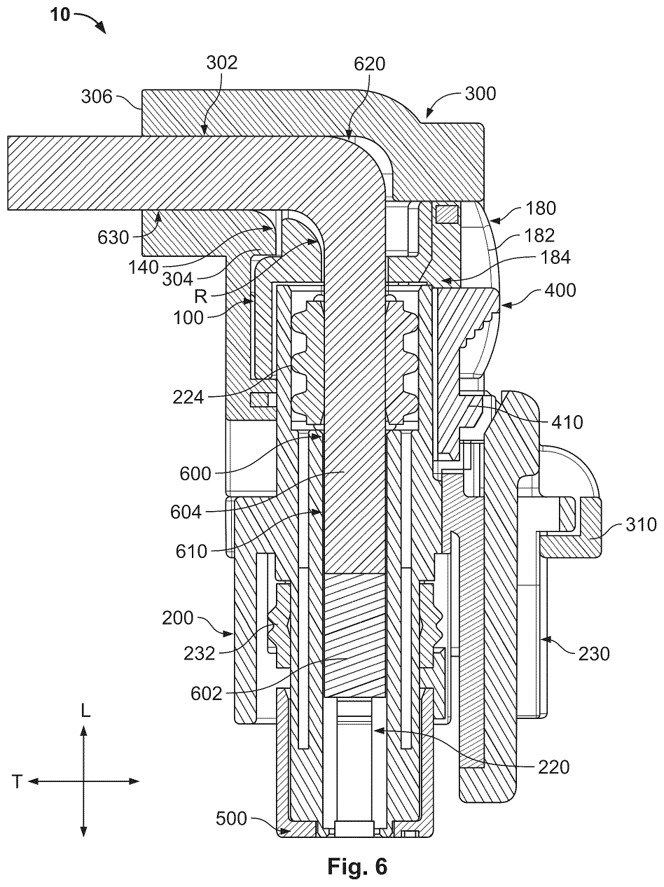

In an embodiment, as shown in FIG. 6, the connector 10 includes a backshell 300. The backshell 300 defines a backshell cable passageway 302 that has an approximately 90° bend from an inlet end 304 of the backshell 300 to an outlet end 306 of the backshell 300. Throughout the present specification, the term “approximately” is intended to mean that the disclosed value is within 10% of the value in the described embodiment. The backshell 300 has a backshell catch 310 at an end opposite the backshell cable passageway 302.

An assembly and functionality of the connector 10 will now be described in greater detail primarily with respect to FIGS. 1, 4, and 5.

As shown in FIGS. 4 and 5, the cable seal 224 is positioned in the recess 218 at the cover end 212 of the body 210. The outer ribs 228 of the cable seal 224 engage the housing 200 to form a seal between the cable seal 224 and the housing 200. The connector seal 232 is positioned around the body 210 of the housing 200 as described above.

The connector 10, as shown in FIGS. 1, 4, and 5, includes a cap 500 positioned over the plug end 216 of the housing 200.

The cover 100 is positioned on the housing 200 as shown in FIGS. 1, 4, and 5. The cover 100 is positioned over and attached to the cover end 212 of the body 210 of the housing 200. The cover 100 is releasably attached to the cover end 212 by engagement of the cover latches 214 of the housing 200 with the cover catches 132 of the cover 100. The cover 100 is moved along the longitudinal direction L over the cover end 212 of the body 210; when the cover catches 132 contact the cover latches 214, either the cover catches 132, the cover latches 214, or both deflect until the cover 100 reaches the position shown in FIGS. 4 and 5 in which the inner surface 122 of the base 110 abuts the cover end 212 of the body 210. In this position, the cover catches 132 and/or the cover latches 214 resiliently return to engage one another and secure the cover 100 to the housing 200 in the position shown in FIGS. 1, 4, and 5. The cover 100 retains the cable seal 224 in the recess 218.

The cover 100 is releasably attached to the housing 200. To release the cover 100 from the position shown in FIG. 4, a user inserts a tool through the access passageway 120 of the cover 100 and into the space between the cover latches 214 and the base 110 of the cover 100. Further insertion of the tool deflects at least one of the cover catches 132 and the cover latches 214 to release their engagement with one another and permit removal of the cover 100.

The connector 10, as shown in FIGS. 1 and 5, includes a connector position assurance (CPA) member 400 positioned in the retention section 180 of the cover 100. The CPA member 400 is positioned in the slot 184 of the retention section 180 and is retained in the slot 184 by engagement of the retention catch 188 with the CPA member 400. The CPA member 400 has a stop 410 that protrudes from the CPA member 400 and, in a first position of the CPA member 400 shown in FIG. 5, is spaced apart from the connection section 230 of the housing 200 along the longitudinal direction L.

A cable 600 and a terminal 700, shown in FIGS. 4 and 5, are inserted into the housing 200 to form the connector 10. The cable 600 includes a conductor 602 and an insulation 604 around the conductor 602. The terminal 700 is electrically and mechanically connected to the conductor 602 at an end of the cable 600 in a portion in which the insulation 604 is removed, for example by crimping or any other type of electrical and mechanical connection between a conductor and a terminal.

The cable 600 with the terminal 700 attached to the cable 600 is inserted into the connector 10 along the longitudinal direction L. During insertion, the terminal 700 contacts and resiliently deflects the retention arm 222 until the terminal 700 and the cable 600 reach the position shown in FIG. 4, in which the retention arm 222 elastically returns and the free end 223 engages the terminal 700 to retain the terminal 700 and the cable 600 connected to the terminal 700 in the housing cable passageway 220.

The cable 600 extends through the housing cable passageway 220, through the cable seal 224 in the recess 218, and out of the connector 10 through the cover cable passageway 114, as shown in FIGS. 4 and 5. The inner ribs 226 of the cable seal 224 abut the insulation 604 of the cable 600 to form a seal between the cable 600 and the housing 200 at the recess 218.

As shown in FIGS. 4 and 5, the connector 10 accommodates a bending of the cable 600. The cable 600 has a first portion 610 positioned in the housing cable passageway 220, a bent portion 620 extending from the first portion 610, and a second portion 630 extending from a side of the bent portion 620 opposite the first portion 610. In the shown embodiment, the second portion 630 extends approximately 90° with respect to the first portion 610.

The bent portion 620 is bent into abutment with the support surface 142 of the support 140. The groove curve 154 matches a bending radius R of the cable 600 and the cable 600 extends along the support surface 142 from the first end 144 to the second end 146, as shown in FIG. 5. The support surface 142 supports a bending radius R of the cable 600 by contacting the cable 600 in the bent portion 120, allowing the cable 600 to be bent to the desired bending radius R while supporting the cable 600 at the desired position and preventing uncontrolled bending beyond the desired radius. The support surface 142 and the support 140 that are integrated into the cover 100 thus prevent damage to the cable 600, such as by kinking or pinching, when the connector 10 is used in an application in which the second portion 630 of the cable 600 extends in a different direction than the first portion 610 of the cable 600.

The cover 100 supports the bent cable 600 in a plurality of different angular exit orientations of the cable 600. In the embodiment of the cover 100 shown in FIGS. 1, 2, 4, and 5, the bent portion 620 of the cable 600 can be positioned in any one of the different discrete grooves 150. A cable width 606 of the cable 600, shown in FIG. 4, is approximately equal to or corresponds to the groove width 152 of each of the discrete grooves 150, and the cable 600 can be positioned in and supported by the support surface 142 in any of the discrete grooves 150. In the embodiment of the cover 100 shown in FIG. 2, the second portion 630 of the cable 600 could exit at any of the discrete grooves 150 that are 90° from one another. In other embodiments with a larger number of discrete grooves 150 and/or with discrete grooves 150 at different angular orientations, the second portion 630 could exit the cover 100 at a plurality of different angular exist orientations about the cover cable passageway 114 that are each supported by the support surface 142. The same cover 100 can thus be used for multiple different applications with different angular exit orientations of the cable 600.

The cover 100′ shown in the embodiment of FIG. 3 can be used in the connector 10 and attached to the housing 200 in the same manner as described above with respect to the cover 100. In the embodiment with the cover 100′, however, the second portion 630 of the cable 600 can be supported by the continuous curve 160 of the support surface 142 at any angular exit orientation about the cover cable passageway 114 within a range; the cover 100′ does not restrict the second portion 630 of the cable 600 to certain discrete angular exit orientations.

As shown in FIG. 6, in an embodiment, the backshell 300 can then be attached to the cover 100 and the housing 200. The backshell catch 310 engages with the connection section 230 of the housing 200 to releasably secure the backshell 300 in the position shown in FIG. 6. The bent portion 620 and the second portion 630 of the cable 600 are retained and positioned in the backshell cable passageway 302 and the backshell 300 further secures the cable 600 in the bent position supported by the support 140. In other embodiments, the backshell 300 can be omitted. In another embodiment, the support 140 could be positioned on the backshell 300 and integrated with the backshell 300, otherwise interacting with the cable 600 as described herein.

The assembled connector 10 can be mated with a mating connector; the connection section 230 secures the connector 10 to the mating connector and the connector seal 232 forms a seal between the connector 10 and the mating connector. The CPA member 400 is movable with respect to the cover 100 within the slot 184 of the retention section 180 from the first position shown in FIG. 5 to a second position shown in FIG. 6. In the second position of the CPA member 400 shown in FIG. 6, the stop 410 of the CPA member 400 prevents the connection section 230 from moving to prevent unintended disconnection of the connector 10 from the mating connector.

1. A cover for a connector, comprising:
a base having an end wall with a cover cable passageway extending through the end wall; and
a support connected to and extending from the end wall around the cover cable passageway, the support has a support surface with a first end adjacent to the cover cable passageway and a second end opposite the first end, the support surface is curved between the first end and the second end to support a bending radius of a cable extending through the cover cable passageway.

2. The cover of claim 1, wherein the support extends around more than half and less than an entirety of a circumference of the cover cable passageway.

3. The cover of claim 1, wherein the support is monolithically formed in a single piece with the base.

4. The cover of claim 1, wherein the base and the support are formed of an insulative material.

5. The cover of claim 1, wherein the support surface has a plurality of discrete grooves separated by at least one ridge along an inner perimeter of the support surface that extends around the cover cable passageway.

6. The cover of claim 5, wherein each of the grooves has a width corresponding to a width of the cable and is positioned around the cover cable passageway to correspond to a different angular exit orientation of the cable.

7. The cover of claim 1, wherein the support surface has a continuous curve that is constant along an inner perimeter of the support surface that extends around the cover cable passageway.

8. A connector, comprising:
a cover with a base and a support, the base has an end wall with a cover cable passageway extending through the end wall, the support is connected to and extends from the end wall around the cover cable passageway, the support has a support surface with a first end adjacent to the cover cable passageway and a second end opposite the first end, the support surface is curved between the first end and the second end; and
a cable extending through the cover cable passageway and bent into abutment with the support surface, the support surface supports a bending radius of the cable.

9. The connector of claim 8, further comprising a housing having a body with a cover end and a plug end opposite the cover end, the cover is positioned over and attached to the cover end.

10. The connector of claim 9, wherein the cover is releasably attached to the cover end of the housing by engagement of a plurality of cover latches of the housing with a plurality of cover catches on an inner surface of the base of the cover.

11. The connector of claim 9, wherein the housing has a housing cable passageway extending through the housing from the cover end to the plug end, the cable is positioned in the housing cable passageway.

12. The connector of claim 11, wherein the cable has a first portion in the housing cable passageway, a bent portion along the support surface, and a second portion on a side of the bent portion opposite the first portion, the second portion extends approximately 90° with respect to the first portion.

13. The connector of claim 12, wherein the second portion extends at one of a plurality of different angular exit orientations about the cover cable passageway that are each supported by the support surface.

14. The connector of claim 12, further comprising a backshell attached to the cover and the housing, the backshell has a backshell cable passageway retaining the second portion of the cable.

15. The connector of claim 11, wherein the housing has a retention arm in the housing cable passageway, the retention arm engages a terminal connected to an end of the cable to retain the terminal and the cable in the housing cable passageway.

16. The connector of claim 11, wherein the housing has a recess at the cover end, a cable seal is positioned in the recess and is retained in the recess by the cover.

17. The connector of claim 16, wherein the recess communicates with the housing cable passageway and the cable extends through the cable seal, which forms a seal between the cable and the housing.

18. The connector of claim 17, wherein the cable seal is formed of an elastomeric material and has a plurality of inner ribs engaging the cable and a plurality of outer ribs engaging the housing.

19. The connector of claim 9, wherein the housing has a connection section extending from the body and a connector seal positioned between the body and the connection section, the connection section secures the connector to a mating connector.

20. The connector of claim 8, wherein the cover has a retention section extending from the base, and further comprising a connector position assurance member positioned in the retention section and movable with respect to the cover.
